(19) United States
(12) Patent Application Publication
(10) Pub. No.: US 2008/0225016 A1
(43) Pub. Date: Sep. 18, 2008

(54) Control panel and washing machine having the same

(75) Inventor: Yong Sok Lee, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/007,689

(22) Filed: Jan. 14, 2008

(30) Foreign Application Priority Data
Mar. 12, 2007 (KR) 10-2007-0024226

(51) Int. Cl. G06F 3/045

(52) U.S. Cl. 345/174

(57) ABSTRACT

A control panel and a washing machine, capable of providing an aesthetic external appearance and preventing characters or symbols which indicate control functions from being erased and preventing the characters or symbols from being displayed when the operation stops or the control functions are not used. The control panel includes a semi-transparent cover, a film disposed behind the semi-transparent cover and printed with a plurality of characters or symbols, a detecting panel disposed behind the film and having a plurality of detecting members detecting a capacitance of a human body, a circuit board having a light emitting unit irradiating light onto the film to display the characters or the symbols of the film on a rear surface of the semi-transparent cover, and a guide member having a plurality of optical paths guiding light irradiated from the light emitting unit into each of the characters or the symbols of the film.

### CROSS-REFERENCE TO RELATED APPLICATIONS

This application claims the benefit of Korean Patent Application No. 10-2007-0024226 filed on Mar. 12, 2007, in the Korean Intellectual Property Office, the disclosure of which is incorporated herein by reference.

### BACKGROUND

1. Field

The present invention relates to a control panel and a washing machine having the same. More particularly, the present invention relates to a control panel and a washing machine having the same capable of providing an aesthetic external appearance and of preventing characters and symbols from being erased.

2. Description of the Related Art

An electronic device, such as a washing machine, includes a control panel that controls an operation of the electronic device and informs an operational state thereof. Korean Patent Unexamined Publication No. 10-2007-0015302 discloses a washing machine having such a control panel.

The control panel disclosed in the above Publication includes a panel forming a front surface of the control panel, a circuit board installed behind the panel, a plurality of control buttons installed at a front surface of the panel in the form of protrusions, and a plurality of tact switches provided on the circuit board such that the tact switches can be pressed when the user manipulates the control buttons.

A display unit and a plurality of light emitting diodes are installed on the circuit board to display operational states of the washing machine, and a transparent display window is formed on the panel to allow the user to check signals of the display unit and the light emitting diodes. Characters or symbols are printed on the front surface of the panel to allow the user to recognize functions of the control buttons.

However, since the plural control buttons protrude from the front surface of the control panel, there is a difficulty in providing an aesthetic external appearance. In addition, since the characters or the symbols frequently make contact with hands of the user, the characters or the symbols are blurred or erased when the washing machine has been used for a long period of time. In addition, in a case that the device is not used (a power off state), since the characters or the symbols are exposed to the user's eyes, an external appearance of the washing machine is degraded and a control error may occur caused by a mistake of the user.

### SUMMARY

Accordingly, it is an aspect of the present embodiment to provide a control panel and a washing machine having the same capable of providing an aesthetic external appearance.

Another aspect of the present embodiment is to provide a control panel and a washing machine having the same capable of preventing characters or symbols that indicate control functions from being erased.

Another aspect of the present embodiment is to provide a control panel and a washing machine having the same capable of preventing characters or symbols that indicate control functions from being displayed when the operation is stopped or the control functions are not used.

Additional aspects and/or advantages will be set forth in part in the description which follows and, in part, will be apparent from the description, or may be learned by practice of the invention.

The foregoing and/or other aspects of the present invention are achieved by providing a control panel, which includes a semi-transparent cover, a film disposed behind the semi-transparent cover and printed with a plurality of characters or symbols, a detecting panel disposed behind the film and having a plurality of detecting members to detect a capacitance of a human body, a circuit board having a light emitting unit irradiating light onto the film to display the characters or the symbols of the film on a rear surface of the semi-transparent cover, and a guide member having a plurality of optical paths guiding light irradiated from the light emitting unit into each of the characters or the symbols.

According to an aspect of the present embodiment, the light emitting unit may include a plurality of light emitting diodes disposed in the plural optical paths.

According to an aspect of the present embodiment, the characters or the symbols displayed on the rear surface of the semi-transparent cover may include characters and symbols displaying operational states of the apparatus, and characters or symbols indicating positions of the plural detecting members.

Further, according to an aspect of the present embodiment, the film may be attached to a front surface of the detecting panel, and the detecting panel may be attached to the rear surface of the semi-transparent cover.

The foregoing and/or other aspects are achieved by providing a washing machine, which includes a control panel that controls an operation of the washing machine, the control panel including a semi-transparent cover, a film disposed behind the semi-transparent cover and printed with a plurality of characters or symbols, a detecting panel disposed behind the film, and having a plurality of detecting members to detect a capacitance of a human body, a circuit board having a light emitting unit irradiating light into the film to display the characters or the symbols of the film on a rear surface of the semi-transparent cover, and a guide member having a plurality of optical paths guiding light irradiated from the light emitting unit into each of the characters or the symbols.

The foregoing and/or other aspects are achieved by providing a control panel for a washing machine, including: a cover to receive a user's touch; a film having at least one symbol printed thereon, the symbol being viewable through the cover; and a detecting panel having at least one detecting member corresponding to each of the at least one symbol, the at least one detecting member detecting a capacitance of the user when the user touches the cover at the symbol.

The cover may be semi-transparent.

The at least one symbol may be an alpha-numeric character.

The control panel may further include a light emitting unit irradiating light onto the film and causing the at least one symbol to be displayed on the cover.

The control panel may further include a control unit causing the light emitting unit to irradiate the light when an operation of the washing machine is running and stopping the irradiation of the light when the operation ends. The control unit may cause the light emitting unit to irradiate the light when the user touches the cover at a viewable position of the at least one symbol.

### BRIEF DESCRIPTION OF THE DRAWINGS

These and/or other aspects and advantages will become apparent and more readily appreciated from the following description of the embodiment, taken in conjunction with the accompanying drawings of which:

FIG. 1 is a perspective view representing an external appearance of a washing machine having a control panel according to the present embodiment;

FIG. 2 is an exploded perspective view representing a control panel according to the present embodiment; and

FIG. 3 is a sectional view representing a control panel according to the present embodiment.

### DETAILED DESCRIPTION OF THE EMBODIMENTS

Reference will now be made in detail to the embodiment, examples of which are illustrated in the accompanying drawings, wherein like reference numerals refer to the like elements throughout. The embodiment is described below to explain the present invention by referring to the figures.

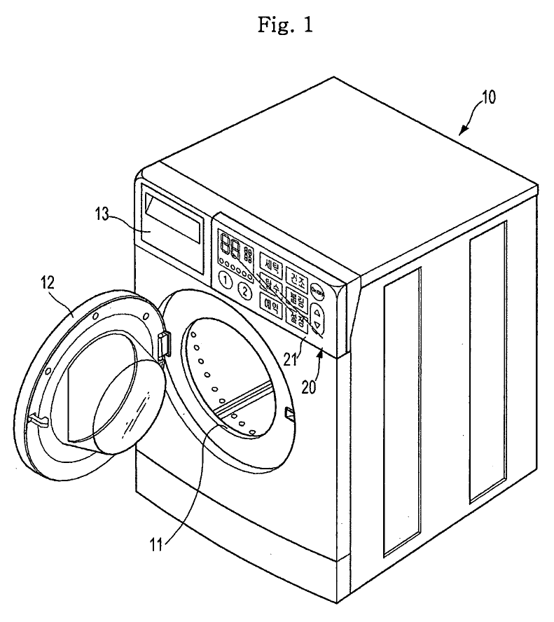

FIG. 1 represents a drum-type washing machine, for example, employing a control panel according to the present embodiment. The washing machine includes a body 10 having an inlet 11 at a front surface thereof to allow a user to input laundry into the body 10, and a door 12 rotatably installed at the front surface of the body 10 to open/close the inlet 11. A detergent supply device 13 that dispenses detergents into the body 10 and a control panel 20 that displays a control state and an operational state of the washing machine are provided on an upper portion of the front surface of the body 10.

Although not shown in the drawings, a tub that contains washing water, a rotational drum rotatably installed in the tub, a driving motor that rotates the rotational drum, a water-supply device that supplies the washing water, and a drain device to perform a drainage operation are provided in the body 10.

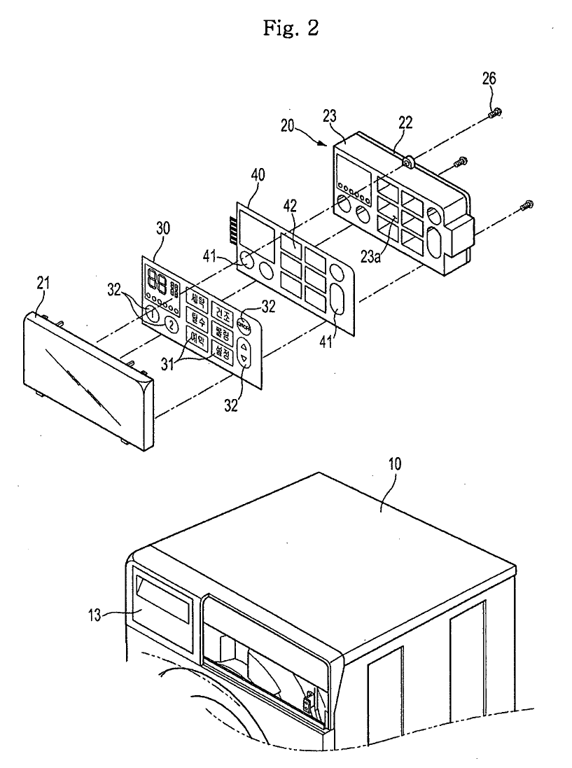

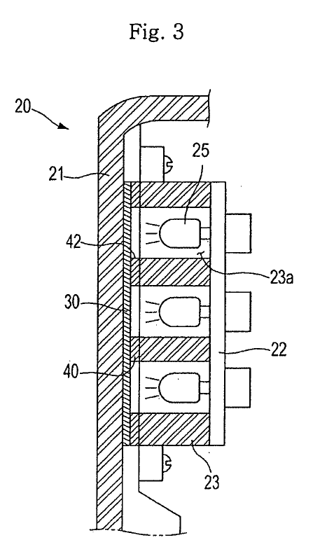

As shown in FIGS. 2 and 3, the control panel 20 installed on the upper portion of the front surface of the body 10 comprises a semi-transparent cover 21, a film 30 printed with characters or symbols 31 and 32, a detecting panel 40 having a plurality of detecting members 41, a circuit board 22 having a plurality of LEDs (light emitting diodes) 25 and a guide member 23 having a plurality of optical paths 23a to guide light.

The semi-transparent cover 21 may include semi-transparent resin or tempered glass. The characters or the symbols 31 and 32 are not printed on a front surface and a rear surface of the semi-transparent cover 21 to provide a simple external appearance.

The film 30 installed behind the semi-transparent cover 21 includes a transparent material that allows light to pass therethrough. The plural characters or symbols 31 and 32 indicating the operational state of the washing machine are printed on the film 30. In addition, the characters or the symbols 31 and 32 indicating the positions of the detecting members 41 of the detecting panel 40 installed behind the film 30 are printed on the film 30.

The detecting panel 40 includes non-contact type detecting members 41 capable of detecting a variable capacitance of a human body. The detecting members 41 are equipped with detecting ICs that detect the capacitance. Thus, when the user touches an outer surface of the semi-transparent cover 21, the detecting members 41 can detect the touch of the user. Such a detecting panel 40 has a structure simpler than that of the conventional control buttons, and a physical force is not applied to the detecting members 41, so a malfunction of the detecting panel 40 rarely occurs as compared with the conventional press-type control buttons.

The detecting panel 40 includes openings 42 allowing light irradiated from the LEDs 25 of the circuit board 22 to pass therethrough, and the openings 42 correspond to the characters or the symbols 31 and 32 of the film 30 installed in front of detecting panel 40. The light irradiated from the LEDs 25 is introduced to the characters or the symbols 31, particularly to the characters or the symbols 31 indicating the operation state.

In addition, the detecting members 41 of the detecting panel 40 correspond to the characters and the symbols 32 indicating the positions of the detecting members 41 among the characters or the symbols on the film 30 provided in front of the detecting panel 40. Openings 42 can be formed in the vicinity of the detecting members 41 or the detecting panel 40 may include a transparent material to allow light to be irradiated to the characters or the symbols 31 and 32 of the film 30 through a region in which the detecting members 41 are positioned.

Each of the LEDs 25 provided on the circuit board 22 individually emit light to irradiate light onto the characters or the symbols 31 and 32 printed on the film 30. To this end, the guide member 23 having the optical paths 23a accommodating the LEDs 25, respectively, is coupled to a front surface of the circuit board 22. That is, the LEDs 25 of the circuit board 22 enter the optical paths 23a of the guide member 23. The optical paths 23a of the guide member 23 correspond to the characters or the symbols 31 and 32 printed on the film 30, respectively. The light of the LEDs 25 is guided through the optical paths 23a to be irradiated to the characters or the symbols 31 and 32, such that the characters and symbols 31 or 32 are projected onto the rear surface of the semi-transparent cover 21. In this manner, as the characters and the symbols 31 or 32 are projected onto the rear surface of the semi-transparent cover 21, the user can check the characters or the symbols 31 and 32 at the front of the semi-transparent cover 21.

When assembling the control panel 20, the film 30 is attached to a front surface of the detecting panel 40 by using double-sided tape (not shown), and the detecting panel 40 is attached to the rear surface of the semi-transparent cover 21 by using the double sided tape. Then, the guide member 23 having the circuit board 22 is coupled to a rear side of the semi-transparent cover 21, and the guide member 23 is fixedly screw-coupled to an inside of the semi-transparent cover 21 by using a plurality of screws 26.

Since power is not applied to the LEDs 25 of the circuit board 22 when the washing machine does not operate, the characters or the symbols 31 and 32 are not displayed at the front surface of the semi-transparent cover 21. That is, in a state in which the operation stops, since the LEDs 25 do not emit light, the characters or the symbols 31 and 32 are not projected onto the rear surface of the semi-transparent cover 21, thereby providing an aesthetic and simple external appearance. At this time, the characters or the symbols 31 and 32 indicating the positions of the detecting members 41 of the detecting panel 40 are not displayed.

When power is applied to the washing machine, the LEDs 25 emit light such that the characters or the symbols 31 and 32, which indicate the positions of the detecting members 41, are projected onto the rear surface of the semi-transparent cover 21. Accordingly, the user can set operational conditions or functions of the washing machine, while checking the control positions displayed on the front surface of the semi-transparent cover 21. When the user touches the front surface of the semi-transparent cover 21, the detecting member 41 of the detecting panel 40 detects a capacitance of the human body, thereby detecting the user's control. Further, if a function is selected in this manner, the LED 25 corresponding to the characters or symbols 31 and 32 emits the light, so the corresponding characters or symbols 31 and 32 are displayed on the semi-transparent cover 21. Since the characters or the symbols 31 and 32 indicating other functions or operation states are not displayed, the user may precisely know the operational state. Accordingly, the control error can be reduced.

As described above, according to the present embodiment, since the function of the control panel is controlled by touching the outer surface of the semi-transparent cover, the control panel represents a simple structure having an aesthetic external appearance as compared with the conventional control panel. In particular, when the operation of the apparatus stops or the control function is not used, since the characters or the symbols are not displayed on the semi-transparent cover, the aesthetic appearance is improved and the control error is reduced.

In addition, according to the present embodiment, since the control panel displays the characters or the symbols in such a manner that the characters or the symbols printed on the film are projected onto the rear surface of the semi-transparent cover by means of the emission of the LED, the characters or the symbols are prevented from being erased even if the washing machine is used for a long period of time.

Although an embodiment has been shown and described, it would be appreciated by those skilled in the art that changes may be made in this embodiment without departing from the principles and spirit of the invention, the scope of which is defined in the claims and their equivalents.

What is claimed is:

1. A control panel to control an operation of an apparatus, the control panel comprising:
a semi-transparent cover;
a film disposed behind the semi-transparent cover and printed with a plurality of characters or symbols;
a detecting panel disposed behind the film and having a plurality of detecting members to detect a capacitance of a human body;
a circuit board having a light emitting unit irradiating light onto the film to display the characters or the symbols of the film on a rear surface of the semi-transparent cover; and
a guide member having a plurality of optical paths guiding light irradiated from the light emitting unit into each of the characters or the symbols of the film.

2. The control panel as claimed in claim 1, wherein the light emitting unit includes a plurality of light emitting diodes disposed in the optical paths.

3. The control panel as claimed in claim 1, wherein the characters or the symbols displayed on the rear surface of the semi-transparent cover include characters and symbols displaying operational states of the apparatus, and characters or symbols indicating positions of the detecting members.

4. The control panel as claimed in claim 1, wherein the film is attached to a front surface of the detecting panel, and the detecting panel is attached to the rear surface of the semi-transparent cover.

5. A washing machine, comprising:
a control panel controlling an operation of the washing machine, the control panel comprising:
a semi-transparent cover;
a film disposed behind the semi-transparent cover and printed with a plurality of characters or symbols;
a detecting panel disposed behind the film, and having a plurality of detecting members to detect a capacitance of a human body;
a circuit board having a light emitting unit irradiating light onto the film to display the characters or the symbols of the film on a rear surface of the semi-transparent cover; and
a guide member having a plurality of optical paths guiding light irradiated from the light emitting unit into each of the characters or the symbols of the film.

6. The washing machine according to claim 5, wherein the light emitting unit includes a plurality of light emitting diodes disposed in the optical paths.

7. The washing machine according to claim 5, wherein the characters or symbols displayed on the rear surface of the semi-transparent cover include the characters or the symbols displaying operational states of the apparatus, and the characters or the symbols indicating positions of the detecting members.

8. The washing machine according to claim 5, wherein the film is attached to a front surface of the detecting panel, and the detecting panel is attached to the rear surface of the semi-transparent cover.

9. A control panel for a washing machine, comprising:
a cover to receive a user's touch;
a film having at least one symbol printed thereon, the symbol being viewable through the cover; and
a detecting panel having at least one detecting member corresponding to each of the at least one symbol, the at least one detecting member detecting a capacitance of the user when the user touches the cover at the symbol.

10. The control panel according to claim 9, wherein the cover is semi-transparent.

11. The control panel according to claim 9, wherein the at least one symbol is an alpha-numeric character.

12. The control panel according to claim 9, further comprising a light emitting unit irradiating light onto the film and causing the at least one symbol to be displayed on the cover.

13. The control panel according to claim 12, further comprising a control unit causing the light emitting unit to irradiate the light when an operation of the washing machine is running and stopping the irradiation of the light when the operation ends.

14. The control panel according to claim 12, further comprising a control unit causing the light emitting unit to irradiate the light when the user touches the cover at a viewable position of the at least one symbol.
